(19) United States
(12) Patent Application Publication
(10) Pub. No.: US 2026/0289851 A1
(43) Pub. Date: Sep. 24, 2026

(54) TRANSFORMING REAL-TIME DATA FEEDS INTO SEQUENTIAL ART PANELS

(71) Applicant: Global Publishing Interactive, Inc., Troy, OH (US)

(72) Inventor: Robert Hoffer, Miami Beach, FL (US)

(21) Appl. No.: 19/551,317

(22) Filed: Feb. 26, 2026

Related U.S. Application Data
(60) Provisional application No. 63/763,601, filed on Feb. 26, 2025.

(51) Int. Cl. G06T 11/60; G06F 3/0483; G06F 16/34; G06F 40/279; G06F 40/30; G06N 20/00; G10L 13/08

(52) U.S. Cl. CPC G06T 11/60; G06F 3/0483; G06F 16/345; G06F 40/279; G06F 40/30; G06N 20/00; G10L 13/08

(57) ABSTRACT

Systems and methods are provided for converting real-time data feeds into sequential art narratives such as comics, webtoons, graphic stories, and video. Respective parts of this conversion can use generative artificial intelligence (AI). A data stream can be provided by capturing live content from sources like news broadcasts, social media updates, and other real-time information streams and processing the data stream through AI algorithms to generate corresponding visual representations of the data stream in the form of sequential art. This transformation process includes analyzing textual and audiovisual input to generate a narrative framework, generating illustrative panels with characters, scenes, and dialogues that reflect the content, and assembling these elements into a coherent sequence. The generated sequential art narratives are delivered to users promptly, providing an engaging and accessible medium for consuming real-time information.

### CROSS-REFERENCE TO RELATED APPLICATIONS

The present patent application claims the priority benefit of U.S. provisional patent application 63/763,601 filed Feb. 26, 2025, the disclosure of which is incorporated by reference herein.

### BACKGROUND OF THE INVENTION

### 1. Field of the Invention

The present disclosure relates to generation of sequential art content, specifically the transformation of real-time data feeds into sequential art panels.

### 2. Description of the Related Art

Real-time information, such as ongoing news updates and series of social media posts, is generally distributed and consumed as serial or episodic content provided in textual or audiovisual-based formats. Such media content may be made accessible over the Internet and thus distributed quickly among online communities and networks (e.g., going viral). Such content may be text-based, such as news articles or social media updates, which may offer a quick way to convey short bursts of information that users can quickly read and digest. Meanwhile, audiovisual formats, including video clips, live broadcasts, and multimedia posts, can enhance engagement by providing more context through sound, images, and motion, which often leads to higher retention of information.

Social media platforms like Twitter, Instagram, and TikTok may allow users to share content including text-based, image-based, or video-based content in real-time or in accordance with a programmed schedule, as well as allowing other users to interact and respond quickly. In both cases, these formats facilitate the rapid spread of information across diverse audiences, thus resulting in frequent use for time-sensitive communications.

Other methods of information dissemination can provide greater engagement with the audience resulting in better retention of the information, but they normally require more time to generate. For example, multimedia educational and informational approaches combine various forms of media—such as text, images, audio, video, and interactive elements—to enhance learning, engagement, and the dissemination of information. These approaches can cater to different learning styles and improve comprehension, retention, and user engagement by using multiple channels of communication. However, such multimedia educational and informational approaches are time-consuming and expensive to produce.

Textbooks and lectures by teachers are common methods for conveying educational information. Explainer videos are short, informative videos designed to explain a product, service, concept, or idea in a clear, concise, and engaging manner. They are often used for marketing, education, or internal communication, aiming to simplify complex topics and make them more accessible to a wide audience. These videos typically use a combination of visuals (such as animations, illustrations, or live-action footage), voiceover narration, and sometimes background music to convey the message effectively. Although some of these techniques can provide greater engagement with audiences, they take longer to generate and therefore have not been suitable for communicating time-sensitive or real-time information, such as breaking news stories.

There is, therefore, a need in the art for improved systems and methods of transforming real-time data feeds into sequential art panels.

### SUMMARY OF THE CLAIMED INVENTION

Embodiments of the present invention include systems and methods for converting real-time data feeds into sequential art panels in such formats as comics, webtoons, and graphic stories. Respective parts of this conversion can use generative artificial intelligence (AI). A data stream can be provided by capturing live content from sources like news broadcasts, social media updates, and other real-time information streams and processing the data stream through AI algorithms to generate corresponding visual representations of the data stream in the form of sequential art. This transformation process includes analyzing textual and audiovisual input to generate a narrative framework, generating illustrative panels with characters, scenes, and dialogues that reflect the content, and assembling these elements into a coherent sequence. The generated sequential art narratives (including digital presentations such as video) are delivered to users promptly, providing an engaging and accessible medium for consuming real-time information.

Methods for generating a graphic art narrative from a data stream may include analyzing a received data stream to distill semantic information from the received data stream, generating a summary based on the semantic information, applying information of the summary to a generative art model to cause the generative art model to generate art panels of a graphic narrative based on the summary, arranging the art panels into a display configuration corresponding to a display platform or display medium to provide a sequential art narrative (including a digital presentation such as video), and distributing the generated digital content to one or more viewers.

A computing apparatus may include a memory storing instructions, and one or more processors that execute the instructions to perform operations that may include analyzing a received data stream to distill semantic information from the received data stream and generating a summary based on the semantic information. The operations include processing information associated with the summary using a generative art model to cause the generative art model to generate, based on the information from the summary, art panels of a graphic narrative. The generative art model includes a trained machine learning (ML) model. The operations include arranging the art panels into a display configuration corresponding to a display medium to provide a sequential-art narrative. The operations include distributing the sequential-art narrative to one or more viewers.

In some aspects, the techniques described herein relate to a non-transitory computer-readable storage medium having embodied thereon a program. The program is executable by a processor to perform a method of generating a graphic story from a data stream. The method includes analyzing a received data stream to distill semantic information from the received data stream and generating a summary based on the semantic information. The method includes processing information associated with the summary using a generative art model to cause the generative art model to generate, based on the information from the summary, art panels of a graphic narrative. The generative art model includes a trained machine learning (ML) model. The method includes arranging the art panels into a display configuration corresponding to a display medium to provide a sequential-art narrative. The method includes distributing the sequential-art narrative to one or more viewers.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates a block diagram for an example of a system for transforming real-time data feeds into sequential art narratives in accordance with some examples.

FIG. 2 illustrates a flow diagram for an example of a method for transforming real-time data feeds into sequential art narratives in accordance with some examples.

FIG. 3 illustrates an example of panels arranged in a page of a graphic narrative, in accordance with some examples.

FIG. 4A illustrates an example of a desktop computing device for displaying a graphic narrative in accordance with some examples.

FIG. 4B illustrates an example of a handheld computing device for displaying a graphic narrative in accordance with some examples.

FIG. 5 illustrates a flow diagram for an example of a method of training, using, and updating a machine learning (ML) model in accordance with some examples.

FIG. 6 illustrates a flow diagram for an example of a method of training, using, and updating a generative adversarial network (GAN) model in accordance with some examples.

FIG. 7A illustrates a block diagram for an example of a transformer neural network architecture in accordance with some examples.

FIG. 7B illustrates a block diagram for an example of an encoder of the transformer neural network architecture in accordance with some examples.

FIG. 7C illustrates a block diagram for an example of a decoder of the transformer neural network architecture in accordance with some examples.

FIG. 8 illustrates a flow diagram for another example of a method of training, using, and updating a machine learning (ML) model in accordance with some examples.

FIG. 9 illustrates an example of a computing system for implementing certain aspects of the present technology, in accordance with some examples.

### DETAILED DESCRIPTION

The disclosed technology addresses the need in the art for rapid generation of real-time information in a form that is engaging to audiences. For example, certain audiences can find information more easy to retain and understand when it is presented in the format of a comic book or an informational slide show or video.

The consumption of real-time information, such as news updates and social media posts, has been predominantly textual or audiovisual. While these formats effectively convey information, they may not always engage users or cater to different learning preferences. Sequential art formats like comics and webtoons offer a visually engaging and narrative-driven medium that can enhance comprehension and retention of information. Creating such content, however, has been labor-intensive and time-consuming, making it impractical for real-time applications.

The systems and methods disclosed herein leverage advancements in generative artificial intelligence (AI) to enable automated content creation based on textual and audiovisual inputs. Using these advancements, the systems and methods disclosed herein can promptly and efficiently transform real-time data feeds into sequential art narratives (including digital presentations such as video). For example, a set of text-based social media posts may be transformed into a more visual medium, in which a set of sequential art panels may illustrate or expand upon the content of the posts. The art panels may be static or may be transformed into generated video in which characters appear within a generated environment, exchange dialogue, and otherwise engage in virtual events within the environment. Similarly, real-life news video clips may be transformed into a fictionalized short film including characters, backgrounds, dialogues, and events, etc., corresponding to the content of the video clips. Sequential art narratives (including digital presentations such as video) may further include newly-generated additional new characters, backgrounds, dialogues, and events that expand beyond the original content upon which the narratives may be based. In addition, different artistic styles (including different storytelling or filming styles) may be applied to transform a modern news article into an animated comedy, period drama, horror film, etc. As discussed herein, different narrative, art direction, and film direction techniques may be applied to make the resulting sequential art content more engaging. As such, the creation of sequential art from live data feeds may be automated and streamlined, making content in real-time that is more engaging and accessible to diverse audiences.

The systems and methods disclosed herein can be used to automatically transform real-time data feeds into sequential art narratives (including digital presentations such as video) using generative artificial intelligence. The systems and methods disclosed herein can capture live content from various sources, including news feeds, social media platforms, and live broadcasts to provide a real-time data stream. This real-time data stream is processed through AI algorithms that analyze textual and audiovisual input to extract key information such as events, characters, dialogues, and emotional tones.

Based on the extracted information, the systems and methods disclosed herein generate illustrative panels that include characters, backgrounds, and dialogues reflective of the real-time content. These panels are assembled by the systems and methods disclosed herein into a coherent sequence following the conventions of comics, webtoons, or other sequential art formats. The generated narratives are then delivered to users promptly through various distribution channels, such as websites, mobile applications, or social media platforms.

The systems and methods disclosed herein can leverage technologies in natural language processing, computer vision, and generative models to automate the creation of sequential art narratives (including digital presentations such as video), thereby enhancing user engagement by presenting real-time information in a visually appealing and narrative-driven format, catering to diverse user preferences and improving information retention.

Regarding data collection and preparation, the systems and methods disclosed herein can collect real-time content from various sources, including news feeds, social media platforms, and live broadcasts to provide a data stream.

The data stream can be processed to analyze, organize, and summarize the semantic content conveyed by the data stream in all its various forms (e.g., images, text, metadata, etc.) For example, a content analysis component of the system can use one or more Natural Language Processing (NLP) models to analyze captions and comments to extract keywords, sentiments, and topics. Additionally or alternatively, the content analysis component can include Named Entity Recognition (NER) models to identify specific entities of interest. Additionally or alternatively, the content analysis component can use image recognition models to analyze image content and identify people, places, objects, etc. The content analysis component can also combine text and image data to create a summary of the data stream.

Using the summary, a narrative generation module can construct a narrative framework The narrative generation module can determine the sequence of events, dialogues, and interactions between characters and generate descriptions of the settings to be depicted in frames of a graphic narrative. The narrative generation module can apply storytelling principles to enhance coherence and engagement. Narrative generation may also be based on a narrative model trained using archetypal and otherwise known (real-life or fictional) narratives and themes to generate new custom narratives based on selected data stream content. Training materials for such known narratives may include templates that can be matched or otherwise selected for use with a particular data stream based on factors such as tone and context. For example, such a narrative generation model may analyze a biographical news story and generate a superhero origin narrative based on the biographical subject and their life events. Social media posts about a group of friends traveling together may be transformed into a graphic novel about adventures, histories, and mysteries related to their travel itinerary. While some narrative generation models may be constrained in generating content based on corresponding content elements of the data stream, different narrative generation models may be trained to take artistic license and generate new, synthetic characters, backgrounds, events, and narrative elements to expand, extend, or otherwise enrich the generated content.

Based on the narrative framework, an art generation module can use one or more generative AI models to create visual content for respective panels of a graphic narrative. For example, generative adversarial networks (GANs) can be used for image generation in specific art styles. Additionally or alternatively, transformer models can be used for text-to-image generation based on narrative descriptions. Further, the art generation module can generate character designs, backgrounds, and visual effects consistent with the narrative and the selected art style. Different art generation models may be trained to apply different artistic styles in the generated static and video content.

An assembly module can integrate the visual elements from the art generation module with dialogues and captions based on the narrative framework from the narrative generation module. Also, the assembly module can arrange panels according to the conventions of the chosen sequential art format (e.g., left-to-right, top-to-bottom). And the assembly module can add speech bubbles, narration boxes, and onomatopoeia where appropriate, resulting in a sequential art narrative (including a digital presentation such as video).

The sequential art narrative (including digital presentation such as video) can be distributed using various formats and applications including, for example, web platforms, mobile applications, social media channels, email newsletters, and sending notifications to users using, for example, push notifications.

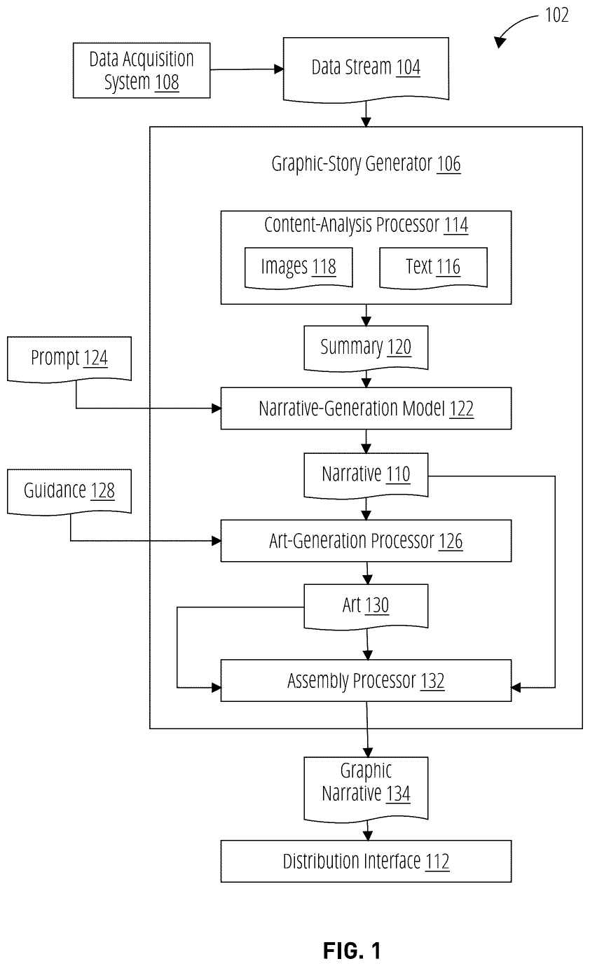

FIG. 1 illustrates a non-limiting example of system 102, which is used for transforming real-time data feeds into sequential art narratives (including digital presentations such as video) using generative artificial intelligence. In response to receiving data stream 104, graphic-story generator 106 outputs graphic narrative 134. Graphic narrative 134 can be a sequential art narrative such as a comic book, manga, manhwa, and manhua, cartoon, webtoon, live action, or other image or video medium that uses a sequence of images together with verbal communication including spoken language and/or written text such as dialogue, narration, descriptions, and explanations. For example, a slide show, animation, video, or other moving picture can also be a sequential art narratives (including digital presentations such as video and other graphic narratives).

Data acquisition system 108 can acquire data in real time from multiple sources to generate data stream 104. For example, data acquisition system 108 can capture real-time data from sources, such as news APIs, social media feeds, live broadcast streams, Really Simple Syndication (RSS) feeds. data acquisition system 108 can ensure that the data is collected continuously or at predefined intervals for real-time processing.

Graphic-story generator 106 can include content-analysis processor 114, narrative-generation model 122, art-generation processor 126, and assembly processor 132. Content-analysis processor 114 analyzes data stream 104 to generate summary 120. For example, content-analysis processor 114 can include analysis components to analyze images 118 in data stream 104 and identify the subject matter and/or semantic meaning represented in images 118. Further, content-analysis processor 114 can include analysis components to analyze text 116 in data stream 104 and identify the entities, sentiments, key phrases, topics, and/or semantic meaning expressed in text 116.

The analysis components of content-analysis processor 114 can include various functionalities, including, for example, natural language processing (NLP), techniques for extracting entities, sentiments, key phrases, and topics, techniques for tokenization, part-of-speech tagging, named entity recognition, and sentiment analysis. Further, the analysis components of content-analysis processor 114 can include various functionalities, including, for example, computer vision and audio analysis, techniques for analyzing images and videos to identify visual elements and transcribe audio content, techniques for object detection, facial recognition, and speech-to-text conversion.

In response to receiving summary 120, narrative-generation model 122 generates narrative 110. For example, narrative 110 can be generated based on the analyzed content in summary 120. Narrative 110 can be a narrative framework that functions as an outline and/or conceptual description of a script, storyboard, or beat sheet. Narrative 110 can provide a sequence of events, dialogues, and interactions between characters. In generating narrative 110, narrative-generation model 122 can apply storytelling principles to enhance coherence and engagement. Prompt 124 can provide direction regarding which storytelling principles to use when generating narrative 110. Further, prompt 124 can provide direction regarding the desired length and structure for narrative 110, for example, an intended audience for graphic narrative 134 or whether to include chapters and how many chapters.

For example, prompt 124 can be based on options selected by a viewer or selected for an intended viewer. According to certain non-limiting examples, prompt 124 can provide direction for generating a screenplay, a narrative outline/framework, or a script that includes dialogue, descriptions of keyframes, information regarding a story's tone/atmosphere, etc. In one example, prompt 124 can state:
Write a screenplay based on the attached summary document. The screenplay should be written for an audience with a fifth-grade education and include descriptions of scenes and characters. The screenplay should include narration describing the background and dialogue between the characters. The screenplay should not deviate from the facts in the attached summary document. The screenplay should follow a narrative format of a news story.

Art-generation processor 126 uses narrative 110 to generate art 130. For example, art-generation processor 126 can use generative artificial intelligence (AI) models to create visual content for the respective panels that are described in narrative 110. According to certain non-limiting examples, generative adversarial networks (GANs) can be used by art-generation processor 126 for image generation in specified art styles. For example, guidance 128 can be used to specify the art style to be used when generating art 130. Art-generation processor 126 can use transformer models for text-to-image generation based on, e.g., panel/scene descriptions in narrative 110. Additionally, art-generation processor 126 can generate character designs, backgrounds, and visual effects consistent with the narrative and selected art style.

For example, guidance 128 can be based on options selected by a viewer or selected for an intended viewer. In one example, guidance 128 can state the artistic style in which art 130 is to be generated, preferences concerning the tone/emotion to be captured in art 130 (e.g., whether the generated art evokes a neutral tone or a persuasive tone), etc.

Based on narrative 110 and art 130, assembly processor 132 can assemble these parts into a coherent and engaging sequential art narrative. For example, assembly processor 132 can integrate visual elements from art 130 with dialogues and captions based on or from narrative 110 to generate panels for graphic narrative 134. Assembly processor 132 can arrange the panels according to the conventions of the chosen sequential art format (e.g., left-to-right, top-to-bottom). Assembly processor 132 can add speech bubbles, narration boxes, and onomatopoeia consistent with narrative 110.

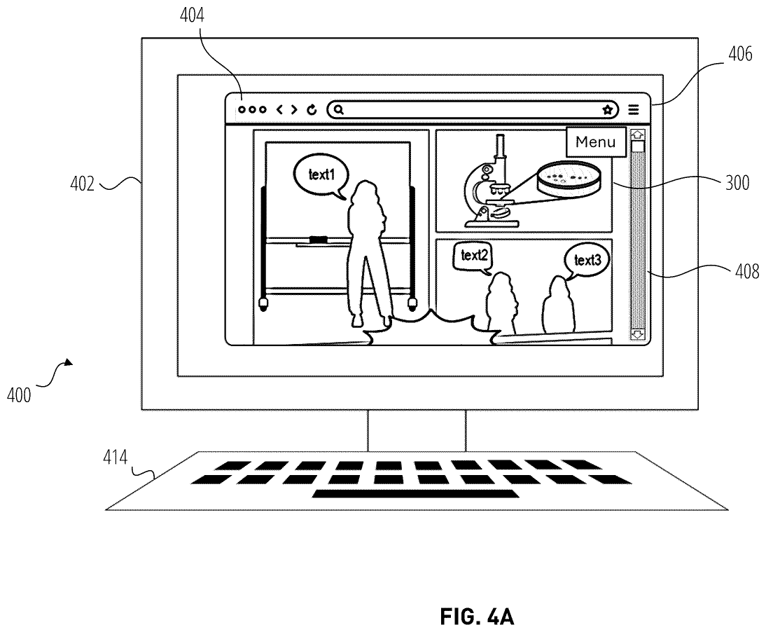

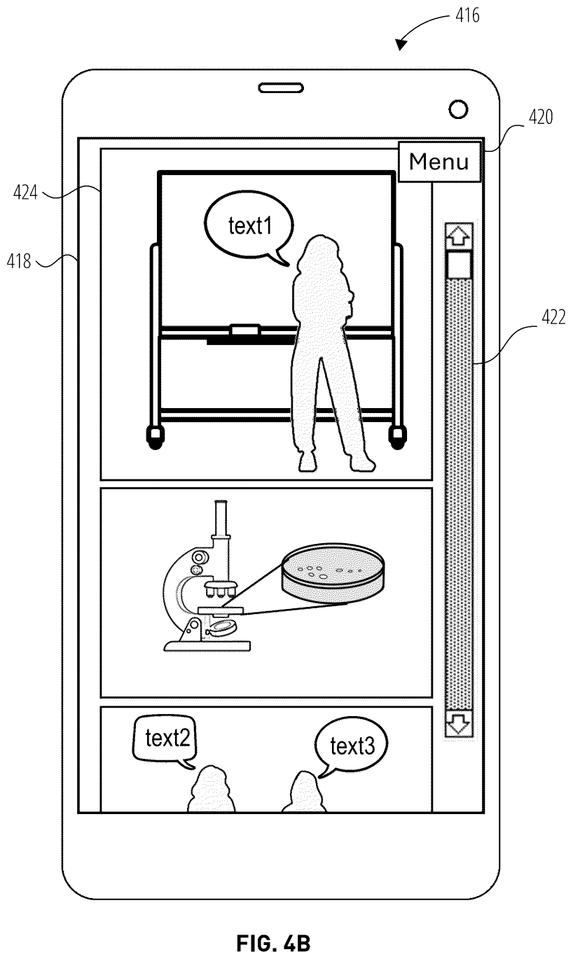

Distribution interface 112 is used to distribute graphic narrative 134 to viewers. According to certain non-limiting examples, distribution interface 112 formats the final sequential art narrative content for distribution. Distribution interface 112 can distribute graphic narrative 134 through web platforms (e.g., web browser 406 illustrated in FIG. 4A), mobile applications (e.g., displayed panels 424 illustrated in FIG. 4B), social media channels, email newsletters, etc. Distribution interface 112 can provide notifications to users upon the release of new content.

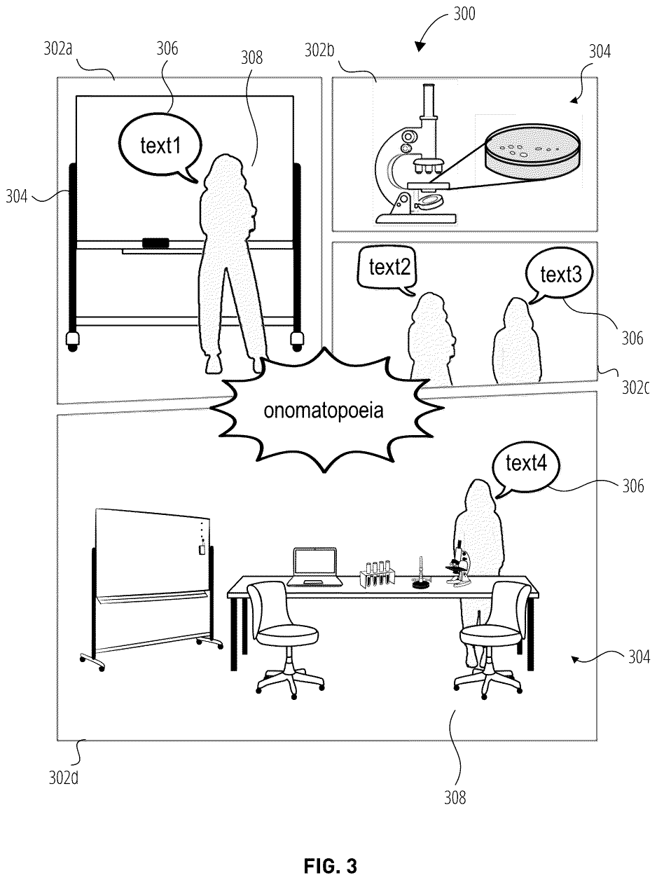

According to certain non-limiting examples, the format and configuration of graphic narrative 134 can be modified based on the application, device, and resolution with which it is to be viewed. The modifications to graphic narrative 134 can include modifying the formatting of the panels to adapt them from a comic book format (or other graphic narrative format) to a format that is compatible with being displayed in an electronic reader (e-reader), a reader application, or in a webpage. For example, on page 300 illustrated in FIG. 3, the size and shape of the panels are not uniform (e.g., some panels are not even rectangular). The panels can be reformatted so that they can be more uniform in shape and so that they be scrolled either vertically or horizontally in an e-reader or mobile application, as illustrated in FIG. 4B.

For example, graphic narrative 134 can be one or more news stories that are generated in a comic book style that is directed to a younger teenage audience. These news stories can be gathered from news agencies and other media that are directed to an adult audience. By repackaging this information in a format that is more engaging and more easily processed by the younger teenage audience, graphic narrative 134 provides a service that encourages and helps this younger audience to learn about current events. Viewers who subscribe to this service can receive notifications as comic book versions of the news stories are generated in real time. Because news stories are most relevant soon after the news breaks, a service that provides graphic narrative 134 in real time is better than a service that is delayed.

According to certain non-limiting examples, content-analysis processor 114 receives data stream 104 and generates therefrom segmented elements, including text 116 and images 118. Text 116 can include text in various forms such as blog posts, news APIs, social media feeds, live broadcast streams (e.g., text generated by speech-to-text applications transcribing audio from broadcasts), and/or RSS feeds.

Data stream 104 can be segmented using various methods and techniques, such as semantic segmentation models, which include Fully Convolutional Network (FCN) methods, U-Net methods, SegNet methods, a Pyramid Scene Parsing Network (PSPNet) methods, and DeepLab methods. The art-generation processor 126 can also segment the data stream 104 using image segmentation models, such as Mask R-CNN, GrabCut, and OpenCV. The art-generation processor 126 can also segment the data stream 104 using Object Detection and Image Segmentation methods, such as fast R-CNN methods, faster R-CNN methods, You Only Look Once (YOLO) methods, PASCAL VOC methods, COCO methods, and ILSVRC methods. The art-generation processor 126 can also segment the data stream 104 using Single Shot Detection (SSD) models, such as Single Shot MultiBox Detector methods. The art-generation processor 126 can also segment the data stream 104 using detection transformer (DETR) models such as Vision Transformer (ViT) methods.

Many of the above methods identify the objects within the segmented elements, but, for other segmentation methods, a separate step is used to identify the object depicted in the segmented elements. This identification step can be performed using a classifier method or a prediction method. For example, identifying images 118 can be performed using an image classifier, such as K-means methods or Iterative Self-Organizing Data Analysis Technique (ISODATA) methods. The following methods can also be trained to provide object identification capabilities for segmented images: YOLO methods, ResNet methods, ViT methods, a Contrastive Language-Image Pre-Training (CLIP) methods, convolutional neural network (CNN) methods, MobileNet methods, and EfficientNet methods.

For text 116 that is embedded in images, a two-step process can be used in which optical character recognition is used, e.g., to map a segment with text to an ordered set of alphanumeric characters (e.g., an ASCII character string of the text), and then a language model is applied to summarize or distill the key ideas of the text. For example, a natural language processing (NLP) model or large language model (LLM) can be used such as a transformer method, a Generative pre-trained transformers (GPT) method, a Bidirectional Encoder Representations from Transformers (BERT) method, or a T5 method.

According to certain non-limiting examples, content-analysis processor 114 can include one or more analysis models that analyze, organize, and/or summarize the semantic content conveyed by data stream 104 in its various forms (e.g., images, text, etc.) For example, analysis models used in content-analysis processor 114 can include Natural Language Processing (NLP) models that analyze captions and comments to extract keywords, sentiments, and topics. Additionally or alternatively, analysis models used in content-analysis processor 114 can include Named Entity Recognition (NER) to identify specific entities such as brands, products, and interests. Additionally or alternatively, content-analysis processor 114 can use image recognition models to analyze image content and identify objects, brands, activities, and contexts. Content-analysis processor 114 can also combine text and image data to create summary 120.

According to certain non-limiting examples, content-analysis processor 114 can include one or more summarization models that make summarizations based on the information conveyed in the data stream 104. For example, the outputs from these summarization models can be summary 120. The inputs to these summarization models can be data stream 104.

According to certain non-limiting examples, the summarization model(s) used in content-analysis processor 114 can include random forest models, support vector machine (SVM) models, deep learning models, recursive neural network (RNN) models, and transformer models. For example, Bidirectional Encoder Representations from Transformers (BERT) models, Generative pre-trained transformers (GPT), and T5 models have been demonstrated to effectively summarize and distill semantic meaning from text data.

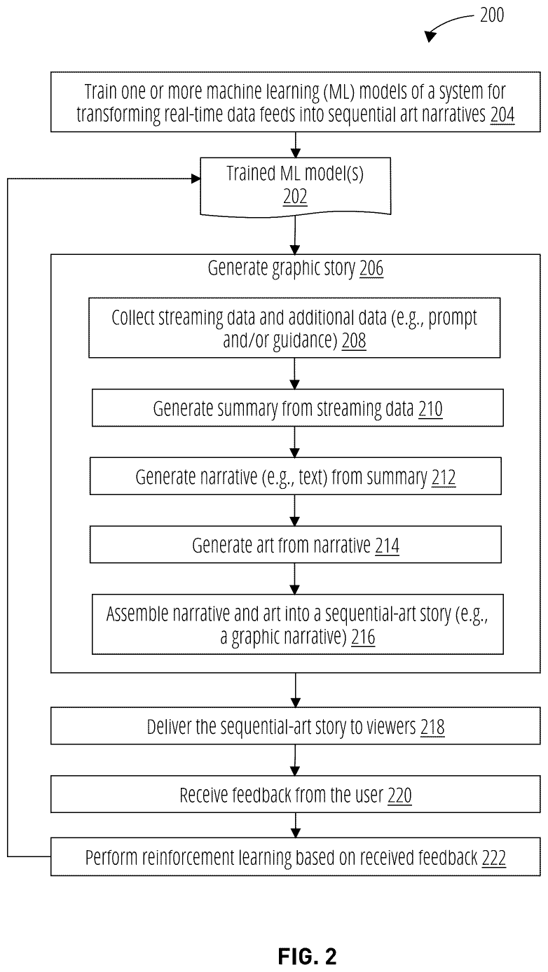

FIG. 2 illustrates an example method 200 for transforming real-time data feeds (e.g., data stream 104) into sequential art narratives (e.g., video or graphic narrative 134) using generative artificial intelligence. Although the example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements method 200 may perform functions at substantially the same time or in a specific sequence.

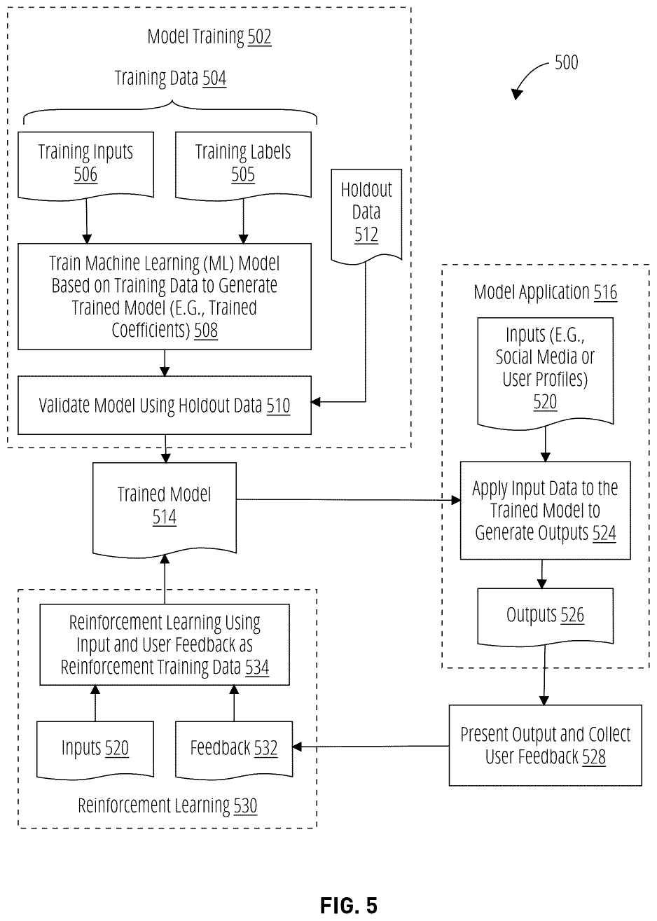

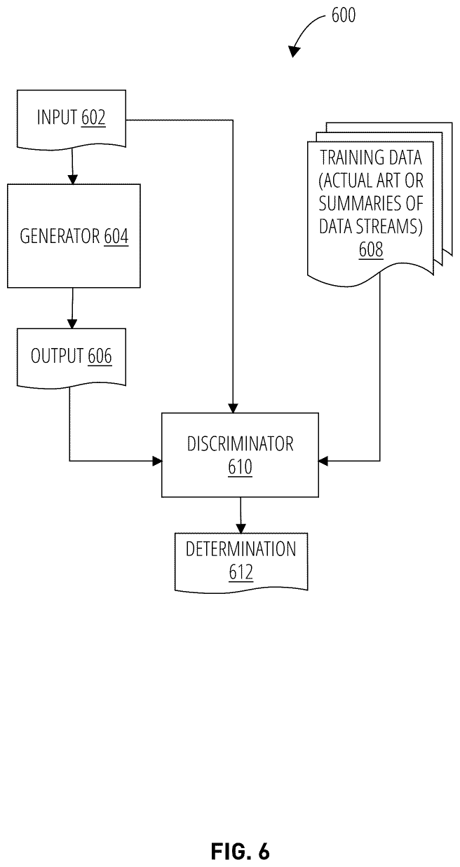

According to some examples, step 204 of the method includes training one or more machine learning (ML) models of a system for transforming real-time data feeds into sequential art narratives (including digital presentations such as video). The system for transforming real-time data feeds into sequential art narratives (e.g., systems 102) can include one or more ML models as discussed above. The respective ML models in the system are trained in accordance with model training 502 in FIG. 5 and/or GAN architecture 600 in FIG. 6, resulting in trained ML model(s).

According to some examples, process 206 of the method includes generating a graphic/sequential art story. For example, graphic-story generator 106 illustrated in FIG. 1 may generate graphic narrative 134 based on data stream 104. Process 206 can include steps 208-216.

According to some examples, step 208 of the method includes collecting streaming data and additional data (e.g., prompt and/or guidance). For example, data acquisition system 108 illustrated in FIG. 1 may collect streaming data and additional data (e.g., prompt and/or guidance).

According to certain non-limiting examples, data acquisition system 108 monitors selected data sources for new content. Upon detection of the new content, data acquisition system 108 retrieves the data and forwards the content to content-analysis processor 114. Further, step 210 can be performed using the techniques and tools described above for data acquisition system 108.

According to some examples, step 210 of the method includes generating summary from streaming data. For example, content-analysis processor 114 illustrated in FIG. 1 may generate summary 120 from streaming data stream 104. Further, step 210 can be performed using the techniques and tools described above for content-analysis processor 114.

According to certain non-limiting examples, step 210 includes processing text data using NLP algorithms to parse the text and identify key elements. Further, step 210 can include processing text data using sentiment analysis to determine the emotional tone, which can be used in step 212 to influence character expressions and scene moods in narrative 110. Step 210 can also include processing audiovisual data to transcribe audio to text for analysis. audiovisual data can also be processed to extract key frames from videos for visual reference and to identify significant visual elements (e.g., locations, objects, people, etc.).

According to some examples, step 212 of the method includes generating a narrative framework (e.g., text) from the summary. For example, narrative-generation model 122 illustrated in FIG. 1 may generate narrative 110 from summary 120. Further, step 212 can be performed using the techniques and tools described above for narrative-generation model 122.

According to certain non-limiting examples, step 212 includes creating a storyboard outlining the sequence of panels. Further, step 212 can include assigning dialogues to characters based on extracted quotes or generated text. Step 212 can include determining pacing and emphasis for storytelling impact.

According to some examples, step 214 of the method includes generating art from narrative. For example, art-generation processor 126 illustrated in FIG. 1 may generate art 130 from narrative 110. Further, step 214 can be performed using the techniques and tools described above for art-generation processor 126.

According to certain non-limiting examples, step 214 includes generating character illustrations matching the described personas. Step 214 can also include creating backgrounds and environments reflective of the settings. Further, art-generation processor 126 can perform step 214 by applying consistent art style across all panels.

According to some examples, step 216 of the method includes assembling narrative and art into a sequential art story (e.g., a graphic narrative). For example, assembly processor 132 illustrated in FIG. 1 may assemble narrative and art into a sequential art story (e.g., a graphic narrative).

According to certain non-limiting examples, step 216 includes combining illustrations with dialogues and captions. Further, the techniques used in step 216 can ensure that the panels generated for graphic narrative 134 have visual coherence and are readable. And generating graphic narrative 134 from art 130 and narrative 110 can be performed to optimize panel layout for the intended reading platform (e.g., mobile devices).

According to some examples, step 218 of the method includes delivering the sequential art story. For example, distribution interface 112 illustrated in FIG. 1 may deliver the sequential art story to viewers and/or subscribers to a service for providing real-time, sequential art stories.

According to certain non-limiting examples, step 218 includes publishing the sequential art narrative (including digital presentation such as video) to designated platforms. Step 218 can also support user interactions, such as commenting or sharing using distribution interface 112.

According to some examples, step 220 of the method includes receiving feedback from the user. For example, distribution interface 112 illustrated in FIG. 1 may receive feedback from the user.

According to some examples, step 222 of the method includes performing reinforcement learning based on received feedback. The method 200 comprises a Trained ML model(s) 202.

According to certain non-limiting examples, art 130 can be generated using one or more generative AI models such as a generative adversarial network (GAN) model; a Stable Diffusion model; a DALL-E Model; a Craiyon model; a Deep AI model; a Runaway AI model; a Colossyan AI model; a DeepBrain AI model; a Synthesia.io model; a Flexiclip model; a Pictory model; a InVideo.io model; a Lumen5 model; or a Designs.ai Videomaker model.

According to certain non-limiting examples, narrative 110 can be generated using one or more language models such as a transformer model, a Generative pre-trained transformers (GPT), a Bidirectional Encoder Representations from Transformers (BERT) model, or a T5 model.

According to certain non-limiting examples, summary 120 can include key elements from images that are identified using a semantic segmentation model and/or an image classifier. For example, the semantic segmentation model can be a Fully Convolutional Network (FCN) model, a U-Net model, a SegNet model, a Pyramid Scene Parsing Network (PSPNet) model, a DeepLab model, a Mask R-CNN, an Object Detection and Segmentation model, a fast R-CNN model, a faster R-CNN model, a You Only Look Once (YOLO) model, a fast R-CNN model, a PASCAL VOC model, a COCO model, a ILSVRC model, a Single Shot Detection (SSD) model, a Single Shot MultiBox Detector model, and a Vision Transformer, ViT) model. The image classifier can be a K-means model, an Iterative Self-Organizing Data Analysis Technique (ISODATA) model, a YOLO model. A ResNet model, a ViT model, a Contrastive Language-Image Pre-Training (CLIP) model, a convolutional neural network (CNN) model, a MobileNet model, and an EfficientNet model.

According to certain non-limiting examples, method 200 and system 102 can be implemented using one or more NLP models, such as a BERT model or a GPT model for text analysis and generation. Method 200 and system 102 can be implemented using one or more image generation models such as StyleGAN or DALL·E for creating art 130. Further, method 200 and system 102 can be implemented using one or more APIs and/or webhooks for real-time data acquisition. Method 200 and system 102 can implement data preprocessing pipelines for efficient processing. Further, method 200 and system 102 can use a cloud infrastructure such as deploying AI models on scalable cloud platforms to handle variable workloads. Cloud based implementation can help to ensure high availability and low latency for real-time performance.

According to certain non-limiting examples, prompt 124 and guidance 128 can be used in method 200 to provide personalization options for generating graphic narrative 134. Personalized options can include the art style, data steam topics, level of detail, the expected education level of the viewers. For example, users can select preferred genres, topics, or art styles. Further, the options can enable users to follow specific subjects or keywords. The personalization options can relate to accessibility features. System 102 can support multiple languages and locations, and system 102 can provide options for text size adjustments and high-contrast visuals.

According to certain non-limiting examples, the graphic narrative 134 can be generated to include various engagement tools. For example, the engagement tools can include interactive elements, such as polls or quizzes within graphic narrative 134.

According to certain non-limiting examples, the graphic narrative 134 can be generated for various applications. For example, the quick generation of graphic narrative 134 from data stream 104 can be helpful for uses in which the information being conveyed in graphic narrative 134 is time-sensitive, such as for news and journalism. For example, graphic narrative 134 can provide easily digestible comic strips that are an alternative to TV news programs and print news stories.

Additionally, the rapid generation of graphic narrative 134 from real-time data can be useful for providing real-time (or nearly real-time) information for live events like sports, concerts, or award shows. Additional applications that can benefit from the rapid and/or reduced labor for generating graphic narrative 134 can include education. For example, rather than taking notes of a lecture, a transcription of the audio recording of the lecture can be converted into graphic narrative 134, which includes both visuals and text in an easily digestible format. Further, graphic narrative 134 may provide a more engaging medium for younger students to learn by converting traditional educational content into engaging visual narratives. Thus, graphic narrative 134 can assist in teaching complex subjects through storytelling to increase engagement and retention.

Graphic narrative 134 can be used to provide a cost-effective mechanism for generating engaging corporate communications and promotional/advertising materials. For example, graphic narrative 134 could be a slide show that is used as an explainer video. Alternatively, graphic narrative 134 could be a visually engaging story-based explanation for a corporate event or training. Also, graphic narrative 134 can be used for company announcements or reports for internal communications.

System 102 and method 200 for generating graphic narrative 134 from data stream 104 have several advantages. First, they enhance viewer's engagement with the content by presenting information in a compelling visual format. Second, they enable real-time content creation by automating the generation process, which enables immediate content availability. Third, system 102 and method 200 are scalable and thus are capable of handling multiple data sources and generating numerous narratives simultaneously (e.g., using a cloud computing platform that allows expansion and contraction of computational resoruces. Fourth, System 102 and method 200 can be versatile such that they are adaptable to various content types and industries.

As discussed above, graphic narrative 134 can be a webtoon or a comic book that is distributed electronically, but graphic narrative 134 is not limited to such. For example, can be an animated moving picture or a slideshow video. For an animated moving picture, art-generation processor 126 can be used to produce animated sequences instead of static panels. Further, graphic narrative 134 can be an interactive narrative (e.g., a choose your own adventure) that incorporates user choices to influence narrative outcomes. Further, graphic narrative 134 can include virtual reality (VR) and/or augmented reality (AR) integration in which the content in data stream 104 is adapted for an immersive experience in an VR/AR environment.

When graphic narrative 134 is in a moving picture or slideshow format, the dialogue can be added using an AI-generated voiceover, as opposed to written text in speech bubbles of a comic book. These voiceovers can be generated using a text-to-speech (TTS) technology to convert written content from narrative 110 into realistic voice narration.

FIG. 3 illustrates a page of graphic narrative 134 (e.g., a comic book, manga, manhwa, manhua, anime, animated moving picture, etc.). Page 300 includes four panels (i.e., a first panel 302a, second panel 302b, third panel 302c, and fourth panel 302d). The respective panels can be segmented into parts, including, e.g., background 304, foreground 308, and bubbles 306. These parts can be further subdivided into elements, such as characters, objects, text, signs, etc. For example, first panel 302a includes background 304, foreground 308, and bubble 306. Similarly, the other panels can generally be segmented into background 304, foreground 308, and bubble 306.

The system and method disclosed herein generate graphic narrative 134 based on data stream 104. For example, data stream 104 can be a multi-media presentation of a health news story or a science lecture that is to be converted to a comic book or webtoon to thereby provide improved engagement for a particular demographic. The style of the art work can be determined by art-generation processor 126 based on guidance 128. The text and narrative flow can be determined by narrative-generation model 122. The order and presentation of the panels can be generated by assembly processor 132 using narrative 110 and art 130.

FIG. 4A illustrates a computing system 400 that can be used by a viewer to view graphic narrative 134. For example, distribution interface 112 can be in a webpages that is accessed using web browser 406. Web browser 406 can include menu ribbon 404 and a window in which page 300 is displayed. According to certain non-limiting examples, page 300 can be reformatted to a different resolution or a different arrangement of the panels, depending on settings for web browser 406 and/or display 402. Scroll bar 408 can be used to scroll the pages of graphic narrative 134.

The computing system 400 includes a display 402 (e.g., a computer monitor) and an input device 414 (e.g., a mouse and/or keyboard). The menu ribbon 404 can provide options for changing a view or navigating to a different URL.

FIG. 4B illustrates a mobile device 416 for displaying graphic narrative 134 within a display 418. According to certain non-limiting examples, the mobile device 416 includes a menu 420 that allows a reader to change the display settings or customize the viewing experience using various drop-down menus and/or options menus. The mobile device 416 can include a scroll bar 422 or other tools to enter user inputs to manually control the path.

The mobile device 416 can be an e-reader that allows the reader to scroll through the panels vertically or horizontally. The mobile device 416 can be a user device such as a smartphone, a tablet, or a computer on which an application or software is installed that provides a multi-modal viewing experience by allowing the reader to view the panels arranged vertically, horizontally, or as a double paged spread. Additionally or Alternatively, a reader can view the graphic narrative using web browser displayed on a monitor or display of a computer. The web browser can be used to access a website or content provider that displays the modified graphic narrative within the web browser or an application of the content provider.

FIG. 5 illustrates an example of training a machine learning (ML) model to generate trained model 514 to which inputs 520 are applied to generate outputs 526. FIG. 5 also illustrates using reinforcement learning 530 to improve trained model 514 based on feedback 532. Method 500 includes three parts: (1) model training 502; (2) model application 516; and (3) reinforcement learning 530.

In model training 502, training data 504 is applied to train the ML model. For example, the ML model can be an artificial neural network (ANN) that is trained via supervised or unsupervised learning using a backpropagation technique to train the weighting parameters between nodes within respective layers of the ANN. Alternatively or additionally, the ML model can include other models, such as a random forest model, a linear regression model, a boosted trees model, a non-linear regression model, and/or a support vector machine, for example. Without loss of generality, the method 500 is illustrated using the non-limiting example of the ML model being an ANN.

In supervised learning, the training data 504 is labeled such that the training data 504 includes training inputs 506 (e.g., historical data including data streams 104) associated with training labels 505 (e.g., historical data representing summaries of the data streams). The inputs in the training data 504 are applied to the ML model, and an error/loss function is generated by comparing the output from the ML model with the desired outputs/labels of the training data 504. Starting with the training inputs 506, the coefficients of the ML model are iteratively updated to reduce an error/loss function. The value of the error/loss function decreases as outputs from the ML model increasingly approximate the desired output. In other words, ANN infers the mapping implied by the training data, and the error/loss function produces an error value related to the mismatch between the desired output and the outputs from the ML model that are produced as a result of applying the training data 504 to the ML model.

Alternatively, for unsupervised learning or semi-supervised learning, training data 504 is applied to train the ML model. For example, the ML model can be an artificial neural network (ANN) that is trained via unsupervised or self-supervised learning using a backpropagation technique to train the weighting parameters between nodes within respective layers of the ANN.

In unsupervised learning, the training data 504 is applied as an input to the ML model, and an error/loss function is generated by comparing the predictions to other data in the training data 504 For example, in time series or prose (ordered words), the ML model can predict the next value in the series based on the previous values, and the error function is generated by comparing the predicted next value in a series to the actual next value in the series. The coefficients of the ML model can be iteratively updated to reduce an error/loss function. The value of the error/loss function decreases as outputs from the ML model increasingly approximate the training data 504.

Relatedly generative adversarial networks (GAN) can be trained using unlabeled training data and unsupervised learning by pitting two ML models (a generative ML model and a classifying ML model) against each other to train the ML models.

In certain implementations, the cost function can use the mean-squared error to minimize the average squared error. In the case of a of multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using various algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML model.

In process 510, method 500 can also include various techniques to prevent overfitting to the training data 504 and for validating the trained process 524. For example, holdout data 512 can be used in process 510 to validate the trained ML model. The holdout data 512 can be a subset of the training data 504 that was not used in process 508, but was instead set aside to be used for validation. Additionally or alternatively, validation can be performed using bootstrapping and random sampling of the training data 504 can be used.

As understood by those of skill in the art, other methods can be used for the ML model including one or more of the following: hidden Markov models, recurrent neural networks (RNNs), convolutional neural networks (CNNs); Deep Learning networks, Bayesian symbolic methods, generative adversarial networks (GANs), support vector machines. As discussed above, the ML model can include a regression algorithms, such as, but not limited to, a Stochastic Gradient Descent Regressors, and/or Passive Aggressive Regressors, etc.

The ML models can also include one or more clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, the ML model can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

In process 524, inputs 520 can be applied to the trained ML model (e.g., an ANN with the trained model 514) to generate the outputs 526.

In process 528, feedback 532 is generated for outputs 526. For example, outputs 526 can be presented to a user via a user interface (UI), and the user can provide indicia whether outputs 526 is correct. Feedback 532 together with inputs 520 can be used as reinforcement training data to improve and update trained model 514. process 534 is performed similarly to process 508, except the training data is augmented to include the reinforcement training data. For example, the contribution to the loss function due to the reinforcement training data can be weighted more than the original training data (e.g., training data 504).

Additionally, some of the ML models in system 102 can be generative adversarial networks (GANs) that are trained using unsupervised learning. FIG. 6 illustrates a GAN architecture 600. The GAN architecture 600 has two parts: the generator 604 and the discriminator 610. The generator 604 receives input 602 (e.g., panel descriptions in narrative 110) and generates output 606 (e.g., a panel of art 130). During training, the generator 604 learns to generate art 130 from one or more art descriptions in narrative 110. The discriminator 610 learns to distinguish art that is generated by generator 604 based on an art description from actual art in a corpus of training data, the actual art corresponding to the art description. Discriminator 610 receives the generated art and the actual art, and discriminator 610 analyzes the two peices of art to make a determination 612 which is the real art. The generator 604 fools the discriminator 610 when the determination 612 is incorrect regarding which of the art received by the discriminator 610 was real.

Both the generator and the discriminator are neural networks with weights between nodes in respective layers, and these weights are optimized by training against the training data 608, e.g., using backpropagation. The instances when the generator 604 successfully fools the discriminator 610 become negative training examples for the discriminator 610, and the weights of the discriminator 610 are updated using backpropagation. Similarly, the instances when the generator 604 is unsuccessfully in fooling the discriminator 610 become negative training examples for the generator 604, and the weights of the generator 604 are updated using backpropagation.

When the GAN architecture 600 is used to train part of the art-generation processor 126, input 602 can be an art description from narrative 110 or tokens summarizing the art description from narrative 110. Once trained, generator 604 would then be used as part of art-generation processor 126.

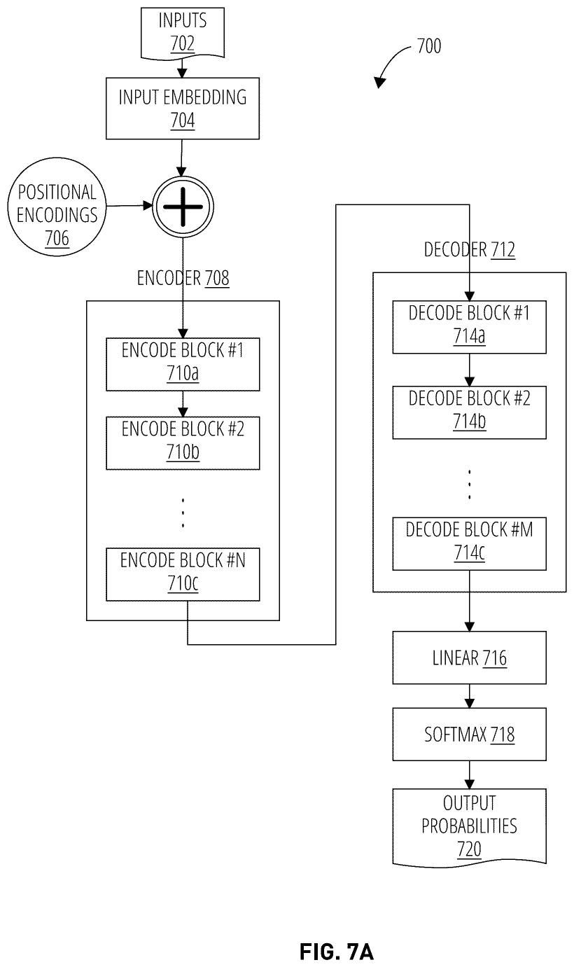

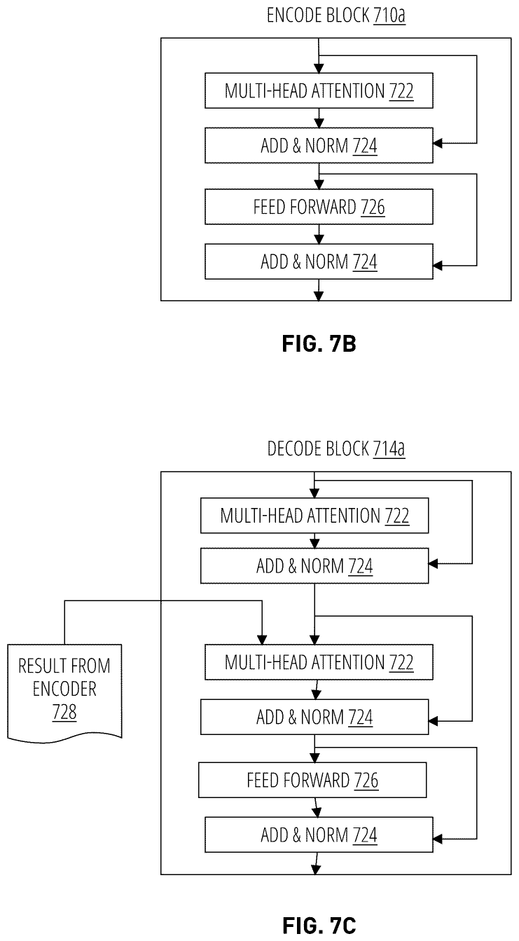

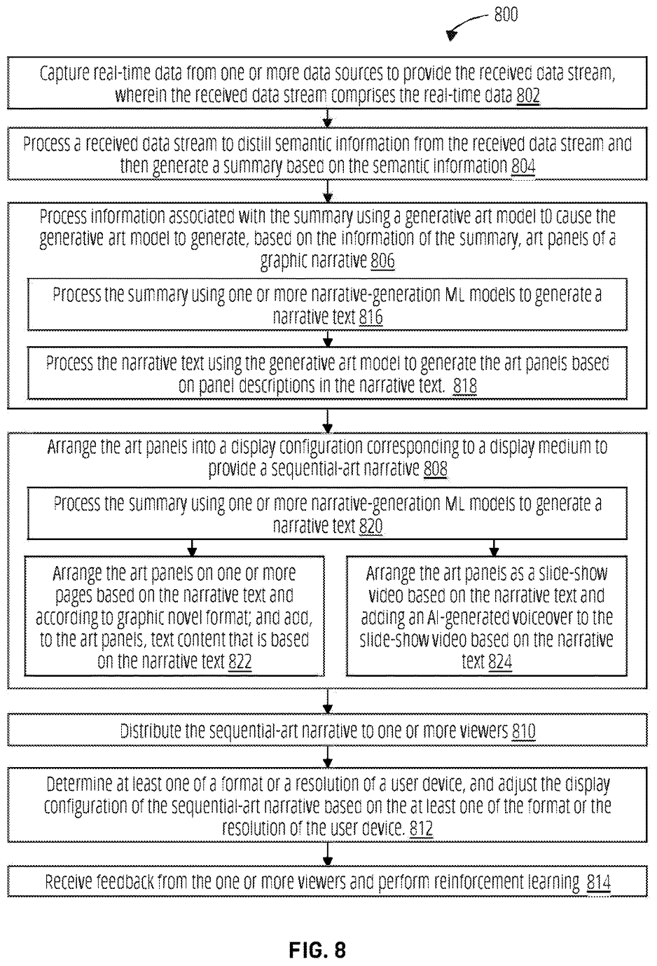

As discussed above, content-analysis processor 114 and/or narrative-generation model 122 can include an ML model, such as a transformer neural network. Examples of ML models that are transformer neural network include, e.g., generative pretrained transformer (GPT) models and Bidirectional Encoder Representations from Transformer (BERT) models. The transformer architecture 700, which is illustrated in FIG. 7A, FIG. 7B, and FIG. 7C, includes inputs 702, an input embedding block 704, positional encodings 706, an encoder 708 (e.g., encode block 710a, decode block 710b, and encode block 710c), a decoder 712 (e.g., decode block 714a, decode block 714b, and decode block 714c), a linear block 716, a softmax block 718, and an output probabilities 720.

The inputs 702 can include data stream 104 conveying information about a news story or other information that is used to generate graphic narrative 134. The transformer architecture 700 can be applied data stream 104 to generate some or all of summary 120.

Additionally or alternatively, inputs 702 can include summary 120 that is used to generate narrative 110. The transformer architecture 700 can be applied to summary 120 to generate narrative 110.

Input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension have the same dimension as the positional encodings, for example.

Positional encodings 706 provide information about the relative or absolute position of the tokens in the sequence. According to certain non-limiting examples, positional encodings 706 can be provided by adding positional encodings to the input embeddings at the inputs to the encoder 708 and decoder 712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 708 uses stacked self-attention and point-wise, fully connected layers. Encoder 708 can be a stack of N identical layers (e.g., N=6), and each layer can be an encode block, as illustrated by encode block 710a shown in FIG. 7B. Each encode block has two sub-layers: (i) a first sub-layer has a multi-head attention block 722 and (ii) a second sub-layer has a feed forward block 726, which can be a position-wise fully connected feed-forward network. The feed forward block 726 can use a rectified linear unit (ReLU).

Encoder 708 uses a residual connection around each of the two sub-layers, followed by an add & norm block 724, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 708, decoder 712 uses stacked self-attention and point-wise, fully connected layers. Decoder 712 can also be a stack of M identical layers (e.g., M=6), and each layer can be a decode block, as illustrated by decode block 714a shown in FIG. 7C. In addition to the two sub-layers (i.e., the sublayer with multi-head attention block 722 and the sub-layer with feed forward block 726) found in an encode block, decode block can include a third sub-layer, which performs multi-head attention over the output of the encoder stack. The second multi-head attention block in FIG. 7C receives two inputs: (i) result from encoder 728 and (ii) the output form add & norm block 724 at the top of decode block 714a.

Similar to encoder 708, decoder 712 uses residual connections around each of the sub-layers, followed by layer normalization. Additionally, the sub-layer with multi-head attention block 722 can be modified in the decoder stack to prevent positions from attending to subsequent positions. This masking, combined with the fact that the output embeddings are offset by one position, can ensure that the predictions for position i can depend only on the known output data at positions less than i.

Linear block 716 can be a learned linear transformation. For example, when transformer architecture 700 is being used to translate from a first language into a second language, linear block 716 can project the output from the last decode softmax block 718 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 718 then turns the scores from linear block 716 into output probabilities 720 (which add up to 1.0). In each position, the index provides for the word with the highest probability and then maps that index to the corresponding word in the vocabulary. Those words then form the output sequence of transformer architecture 700. The softmax operation is applied to the output from linear block 716 to convert the raw numbers into output probabilities 720 (e.g., token probabilities).

FIG. 8 illustrates an example method 800 for generating a graphic story from a data stream. Although the example method 800 depicts a particular sequence of operations, the sequence may be altered without departing from the scope of the present disclosure. For example, some of the operations depicted may be performed in parallel or in a different sequence that does not materially affect the function of method 800. In other examples, different components of an example device or system that implements method 800 may perform functions at substantially the same time or in a specific sequence.

According to some examples, step 802 of the method includes capturing real-time data from one or more data sources to provide a received data stream, wherein the received data stream comprises the real-time data.

According to some examples, step 804 of the method includes analyzing the received data stream to distill semantic information from the received data stream and generating a summary based on the semantic information.

According to some examples, process 806 of the method includes processing information associated with the summary using a generative art model to cause the generative art model to generate, based on the information of the summary, art panels of a graphic narrative at process 806. According to certain non-limiting examples, the generative art model is a generative art model machine learning (ML) model. In some examples, the information associated with the summary includes at least a portion of the summary.

According to certain non-limiting examples, process 806 of the method include applying the information associated with the summary to the generative art model to cause the generative art model to generate, based on the information of the summary, art panels of the graphic narrative.

According to certain non-limiting examples, process 806 can include step 816 and step 818. Step 816 the method can include processing the summary (and/or the information) using one or more narrative-generation ML models to generate a narrative text. In some examples, step 816 can include applying the summary to the one or more narrative-generation ML models to generate the narrative text. Step 818 the method can include processing the narrative text using the generative art model to cause the generative art model to generate the art panels based on panel descriptions in the narrative text. In some examples, step 818 can include applying the narrative text to the generative art model thereby causing the generative art model to generate the art panels based on the panel descriptions in the narrative text.

According to certain non-limiting examples, process 806 can include analyzing the received data stream using natural language processing to identify key phrases and elements from text in the received data stream and analyzing the received data stream using an image ML model to identify key frames and objects in image data (e.g., at least one of an image or a video) in the received data stream. According to certain non-limiting examples, the summary includes the key phrases and elements and the key frames and objects.

According to some examples, process 808 of the method includes arranging the art panels into a display configuration corresponding to a display medium to provide a sequential-art narrative. Process 808 can include step 820 and either step 822 or step 824. The display medium can be a display platform, a page, a computer monitor, a display of a tablet or smart phone, a display of an e-reader, any other medium type, or a combination thereof.

According to some examples, step 820 of the method includes processing the summary using one or more narrative-generation ML models to generate a narrative text. According to some examples, step 820 includes applying the summary to the one or more narrative-generation ML models to generate the narrative text.

According to some examples, step 822 of the method includes arranging the art panels on one or more pages based on the narrative text and according to graphic novel format; and add, to the art panels, text content that is based on the narrative text. The text content can include at least one of a speech bubble, a thought bubble, or a narration box.

According to some examples, step 824 of the method includes arranging the art panels as a slide-show video based on the narrative text and adding an AI-generated voiceover to the slide-show video based on the narrative text.

According to some examples, step 810 the method includes distributing the sequential-art narrative to one or more viewers.

According to some examples, step 812 of the method includes determining at least one of a format or a resolution of a user device and adjusting the display configuration of the sequential-art narrative based on the at least one of the format or the resolution of the user device.

According to some examples, step 814 the method includes receiving feedback from the one or more viewers and perform reinforcement learning. For example, step 814 can include receiving feedback from the one or more users regarding the content of the sequential art narrative, where the feedback may include indicia of a correctness, engagement, or other reactions to its content. Further, step 814 can include generating reinforcement training data based on the feedback and performing reinforcement learning of at least one of an ML model for analyzing the received data stream, the generative art model, or an ML model for arranging the art panels into the display configuration.

According to certain non-limiting examples, the received data stream comprises the real-time data. Further, the one or more data sources can include at least one of a media broadcast application programming interface (API), a news API, an educational API, a social media feed, a live broadcast stream, or a really simple syndication (RSS) feed,

According to certain non-limiting examples, the real-time data includes text, audiovisual content, or a combination thereof.

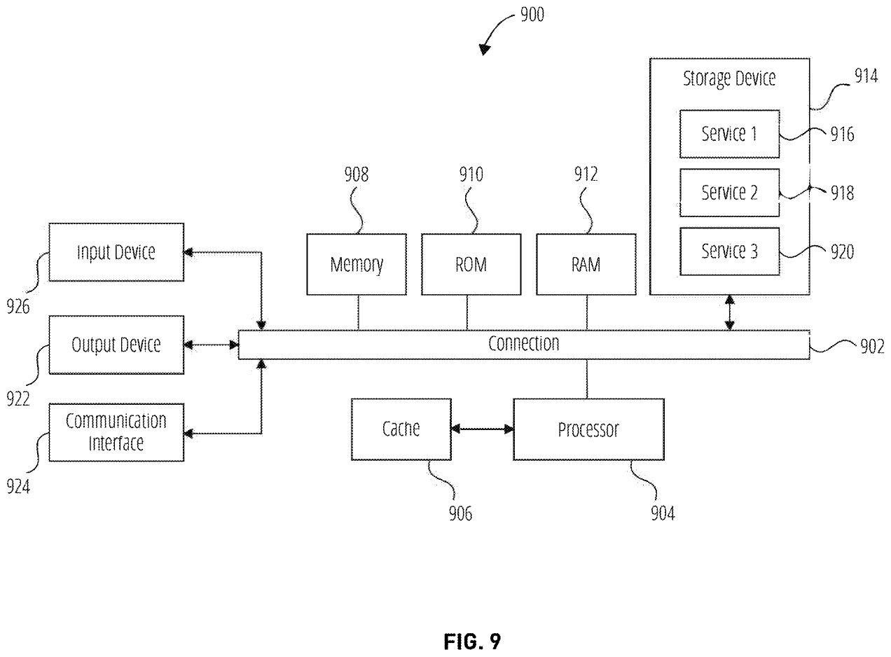

FIG. 9 shows an example of computing system 900. The computing system 900 can be system 102, computing system 400, mobile device 416. The computing system 900 can perform the functions or processes of one or more steps in method 200, method 800, or the functions of system 102, computing system 400, mobile device 416. The computing system 900 can be part of a distributed computing network in which several computers perform respective steps in method 500, GAN architecture 600, method 200, method 800, transformer architecture 700 and/or the functions of system 102, computing system 400, mobile device 416. The computing system 900 can be connected to the other parts of the distributed computing network via connection 902 or communication interface 924. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (e.g., ROM 910) and random access memory (e.g., RAM 912) to processor 904. Computing system 900 can include a cache of high-speed memory 906 connected directly with, in close proximity to, or integrated as part of processor 904.

Processor 904 can include any general-purpose processor and a hardware service or software service, such as services 916, 918, and 920 stored in storage device 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data that cause or otherwise configure a general-purpose computer, special-purpose computer, or special-purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for generating graphical art panels from data streams, the method comprising:
monitoring a data stream sent over a communication network from a content source system;
extracting semantic information from the data stream based on one or more analyses of content associated with the data stream;
generating a set of art panels based on a summary of the data stream that includes the semantic information by using a generative art model trained to transform summaries into art panels; and
distributing the set of art panels to a recipient device configured to render a display of the art panels within a sequential configuration.

2. The method of claim 1, further comprising:
determining at least one of a format or a resolution of the recipient device, and
adjusting the sequential configuration based on at least one of the format or the resolution of the recipient device.

3. The method of claim 1, wherein the semantic information extracted from the data stream includes real-time data that is further extracted in real-time.

4. The method of claim 1, wherein the content source system includes at least one of a media broadcast application programming interface (API), a news API, an educational API, a social media feed, a live broadcast stream, or a really simple syndication (RSS) feed.

5. The method of claim 1, further comprising generating the summary by using one or more natural language processing models to identify key words and phrases from language elements in the data stream.

6. The method of claim 1, further comprising generating the summary by using one or more image ML models to identify key frames and objects from image elements in the data stream.

7. The method of claim 1, further comprising generating the summary by using one or more narrative-generation ML models to generate narrative text characterizing a narrative of the data stream based on the extracted semantic information.

8. The method of claim 7, wherein the sequential configuration corresponds to a graphic novel format, and further comprising:
arranging the art panels in a sequence within the sequential configuration on one or more pages of the graphic novel format based on the narrative text; and
adding text content to the art panels, wherein the added text is based on the narrative text, wherein the text content includes at least one of a speech bubble, a thought bubble, or a narration box.

9. The method of claim 7, wherein the sequential configuration corresponds to a slide-show format, and further comprising:
arranging the art panels as a slide-show video based on the narrative text; and
adding an AI-generated voiceover to the slide-show video, wherein the AI-generated voiceover is based on the narrative text.

10. The method of claim 1, further comprising:
generating reinforcement training data based on feedback from the recipient device; and
updating reinforcement learning of at least one of the generative art model, a narrative-generation ML model, a natural language processing model, and image ML model.

11. A computing apparatus for generating graphical art panels from data streams, the apparatus comprising:
memory that stores a generative art model trained to transform summaries into art panels a communication interface that receives a data stream sent over a communication network from a content source system; and
a processor that executes instructions stored in memory, wherein the processor executes the instructions to:
extract semantic information from the data stream based on one or more analyses of content associated with the data stream, and
generate a set of art panels based on a summary of the data stream that includes the semantic information by using a generative art model trained to transform summaries into art panels,
wherein the communication interface distributes the set of art panels to a recipient device configured to render a display of the art panels within a sequential configuration.

12. The computing apparatus of claim 11, wherein the processor executes further instructions to:
determine at least one of a format or a resolution of the recipient device, and
adjust the sequential configuration based on at least one of the format or the resolution of the recipient device.

13. The computing apparatus of claim 11, wherein the semantic information extracted from the data stream includes real-time data that is further extracted in real-time.

14. The computing apparatus of claim 11, wherein the content source system includes at least one of a media broadcast application programming interface (API), a news API, an educational API, a social media feed, a live broadcast stream, or a really simple syndication (RSS) feed.

15. The computing apparatus of claim 11, wherein the processor executes further instructions to generate the summary by using one or more natural language processing models to identify key words and phrases from language elements in the data stream.

16. The computing apparatus of claim 11, wherein the processor executes further instructions to generate the summary by using one or more image ML models to identify key frames and objects from image elements in the data stream.

17. The computing apparatus of claim 11, wherein the processor executes further instructions to generate the summary by using one or more narrative-generation ML models to generate narrative text characterizing a narrative of the data stream based on the extracted semantic information.

18. The computing apparatus of claim 17, wherein the sequential configuration corresponds to a graphic novel format, and wherein the processor executes further instructions to:
arrange the art panels in a sequence within the sequential configuration on one or more pages of the graphic novel format based on the narrative text; and
add text content to the art panels, wherein the added text is based on the narrative text, wherein the text content includes at least one of a speech bubble, a thought bubble, or a narration box.

19. The computing apparatus of claim 17, wherein the sequential configuration corresponds to a slide-show format, and wherein the processor executes further instructions to:
arrange the art panels as a slide-show video based on the narrative text; and
add an AI-generated voiceover to the slide-show video, wherein the AI-generated voiceover is based on the narrative text.

20. The computing apparatus of claim 11, wherein the processor executes further instructions to:
generate reinforcement training data based on feedback from the recipient device; and
update reinforcement learning of at least one of the generative art model, a narrative-generation ML model, a natural language processing model, and image ML model.

21. A non-transitory computer-readable storage medium having embodied thereon a program executable by a processor to perform a method for generating graphical art panels from data streams, the method comprising:
monitoring a data stream sent over a communication network from a content source system;
extracting semantic information from the data stream based on one or more analyses of content associated with the data stream;
generating a set of art panels based on a summary of the data stream that includes the semantic information by using a generative art model trained to transform summaries into art panels; and
distributing the set of art panels to a recipient device configured to render a display of the art panels within a sequential configuration.

22. A method for generating a graphic story from a data stream, the method comprising:
analyzing a received data stream to distill semantic information from the received data stream;
generating a summary based on the semantic information;
processing information associated with the summary using a generative art model to cause the generative art model to generate a real-time video narrative, wherein the generative art model includes a trained machine learning (ML) model;
distributing the real-time video narrative to one or more viewers.
